(19) United States
(12) Patent Application Publication
(10) Pub. No.: US 2007/0089664 A1
(43) Pub. Date: Apr. 26, 2007

(54) Flag with mesh screen

(75) Inventor: Jim Christianson, Colchester, CT (US)

Correspondence Address: TOPE-MCKAY & ASSOCIATES, 23852 PACIFIC COAST HIGHWAY #311, MALIBU, CA, 90265, US

(73) Assignee: JAKKS PACIFIC, INC.

(21) Appl. No.: 11/315,703

(22) Filed: Dec. 20, 2005

Related U.S. Application Data
(60) Provisional application No. 60/730,082, filed on Oct. 24, 2005.

(51) Int. Cl. G09F 17/00

(52) U.S. Cl. 116/173

(57) ABSTRACT

The present invention relates to the field of wind accessories. More specifically, the present invention pertains to wind accessories comprising mesh panels and non-mesh panels with appliqués. The addition of the mesh panels helps to prevent early fraying and tattering of the wind accessory.

### PRIORITY CLAIM

The present application is a non-provisional patent application, claiming the benefit of priority of U.S. Priority Application No. 60/730,082, filed on Oct. 24, 2005, entitled, “Kite and Release Mechanism.”

### BACKGROUND OF THE INVENTION

(1) Technical Field

The present invention relates to the field of wind accessories. More specifically, the present invention pertains to wind accessories comprising mesh panels and non-mesh panels.

(2) Background

One problem with existing wind accessories is that a force produced by the wind upon the wind accessory causes the wind accessory to fray and tatter. Additionally, the force of the wind may also cause the wind accessory to be displayed in a manner which makes it difficult to see the wind accessory. For example, if the wind accessory is a flag, and the wind is blowing hard, the flag may be forced into a position parallel with the ground, which would make the flag difficult to see. What is needed is a wind accessory that overcomes the afore mentioned limitations.

### SUMMARY OF THE INVENTION

The present invention provides a system and a method that overcomes the aforementioned limitations and fills the aforementioned needs by providing wind accessories comprising of mesh panels and non-mesh panels.

In one aspect of the present invention, a wind accessory comprises a non-mesh border; a mesh panel connected with at least a portion of the non-mesh border; and a non-mesh appliqué connected with at least a portion of the mesh panel.

In another aspect of the present invention, the non-mesh panel connected with at least a portion of the non-mesh border and a portion of the mesh panel.

In a further aspect of the present invention, the non-mesh border has a first thread density; and the non-mesh appliqué has a second thread density, and wherein the first thread density is greater than the second thread density.

In still another aspect of the present invention, the wind accessory has a first side and a second side and a second non-mesh appliqué, and wherein the mesh panel is visible from both the first side and the second side, the non-mesh appliqué is visible from the first side, and the second non-mesh appliqué is visible from the second side.

In a yet further aspect of the present invention, the wind accessory wherein the non-mesh border comprises of at least two non-mesh border panels.

In another aspect of the present invention, the wind accessory is a flag.

In still another aspect of the present invention, the wind accessory is substantially tubular.

In a further aspect of the present invention, the wind accessory is a windsock.

In a yet further aspect of the present invention, the wind accessory is a kite.

In another aspect of the present invention, a method of forming a wind accessory comprising acts of obtaining a non-mesh border; obtaining a mesh panel; connecting a mesh panel with at least a portion of the non-mesh border; and applying a non-mesh appliqué with at least a portion of the mesh panel.

In still another aspect of the present invention, the method further comprises acts of obtaining a non-mesh panel and connecting the non-mesh panel with at least a portion of the mesh panel.

In a further aspect of the present invention, the method comprising the act of obtaining a non-mesh border, comprises an act of selecting a material having a first thread density; and the act of obtaining a non-mesh appliqué comprises an act of selecting a material having a second thread density, wherein the first thread density is greater than the second thread density.

In a yet further aspect of the present invention, the method comprises the act of obtaining a non-mesh border comprise acts of joining a first non-mesh border panel with a second non-mesh border panel.

In another aspect of the present invention, the method comprises the act of obtaining a mesh panel further comprises an act of obtaining a tubular mesh panel.

In still another aspect of the present invention, the method comprises the act of changing the properties of a wind accessory comprising acts of determining an application for the wind accessory; selecting a mesh panel having a number of holes per area based on the application; and constructing the wind accessory by: connecting the mesh panel to a non-mesh border; and applying a non-mesh appliqué with at least a portion of the mesh panel.

In a further aspect of the present invention, the method comprises the act of constructing the wind accessory further comprises acts of obtaining a non-mesh panel; and connecting the non-mesh panel with at least a portion of the mesh panel.

In a yet further aspect of the present invention, the method comprises the act of constructing the wind accessory further comprises acts of selecting a material for the non-mesh border having a first thread density; and selecting a material for the appliqué having a second thread density, wherein the first thread density is greater than the second thread density.

In another aspect of the present invention, the method comprises the act of joining a first non-mesh border panel with a second non-mesh border panel, whereby the non-mesh border is formed.

In still another aspect of the present invention, the method comprises the act of constructing the wind accessory further comprises an act of forming the wind accessory into a tubular form.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1a depicts a first side of a first embodiment of the present invention including a flag with mesh panels illustrating water and non-mesh parts being used to illustrate fish and water;

FIG. 1b depicts a second side of the first embodiment of the present invention, wherein the mesh panels on the first side are the same mesh panels depicted on the second side;

FIG. 2a depicts a first side of a second embodiment of the present invention including a flag with mesh panels illustrating sky, and non-mesh panels illustrating a lighthouse and clouds;

FIG. 2b depicts a second side of the second embodiment of the present invention, wherein the mesh panels on the first side are the same mesh panels depicted on the second side;

FIG. 3a depicts a first side of a third embodiment of the present invention including a wind sock with mesh panels illustrating a background and non-mesh panels illustrating flowers on the background;

FIG. 3b depicts a second side of the third embodiment of the present invention; and

FIG. 4 depicts a fourth embodiment of the present invention.

### DETAILED DESCRIPTION

The present invention relates to the field of wind accessories. More specifically, the present invention pertains to wind accessories comprising mesh panels and non-mesh panels. The following description, taken in conjunction with the referenced drawings, is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore it should be noted that, unless explicitly stated otherwise, the figures included herein are illustrated diagrammatically and without any specific scale, as they are provided as qualitative illustrations of the concept of the present invention.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

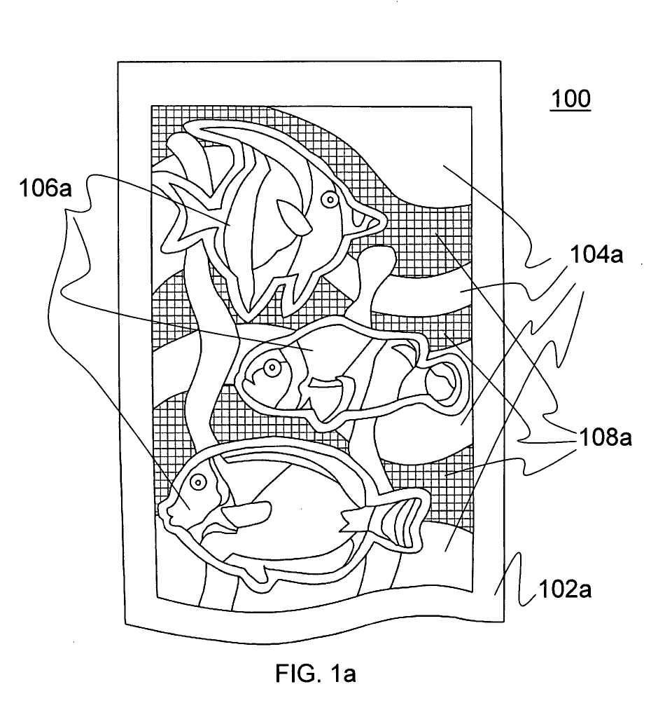

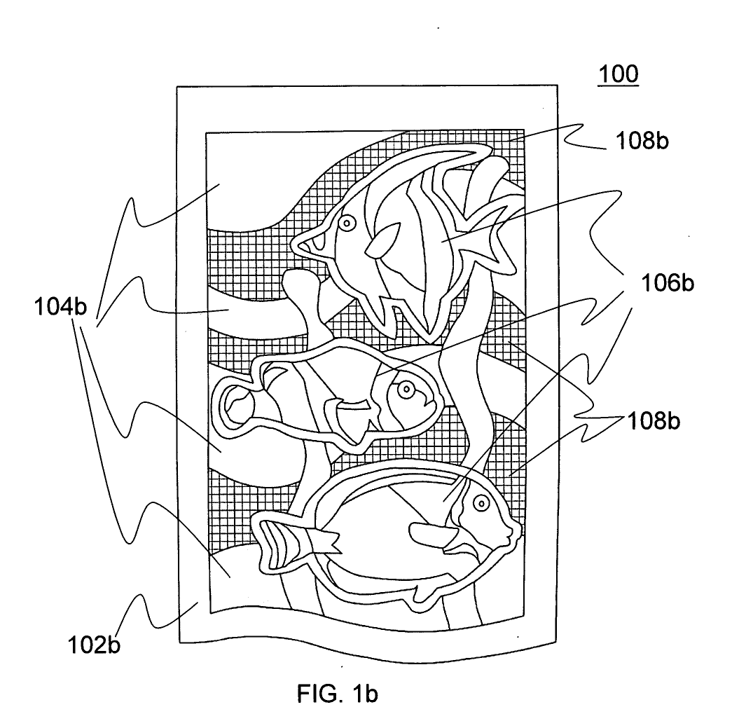

FIG. 1a depicts a first side of a first embodiment of the present invention. The first embodiment is a wind accessory 100 depicting a scene of three fish swimming in water. The ocean scene depicted is just one of many scenes that may be depicted on such a wind accessory. The wind accessory 100 comprises a non-mesh border 102a, non-mesh panels 104a, non-mesh appliqués 106a, and mesh panels 108a. The mesh panels 108a are connected with at least one portion of the non-mesh border 102a. The non-mesh panels 104a are connected with at least one portion of the non-mesh border 102a. Finally, the non-mesh appliqués 106a are connected with at least a portion of the non-mesh panels 104a and/or the mesh panels 108a.

Many different types of materials may be used in constructing the wind accessory 100. For example, the non-mesh portions of the wind accessory 100, such as the non-mesh border 102a, the non-mesh panels 104a and the non-mesh appliqués 106a may be constructed from a nylon fabric. The non-mesh portions need not be constructed out of the same type of fabric. For example, the non-mesh border 102a may be constructed from a nylon fabric with a higher thread density than the non-mesh appliqués 106a. The mesh panels 108a may also be constructed out of any fabric, such as nylon. The number of holes per square inch (or area) for the mesh panels 108a may be varied depending upon the desired look and application of the wind accessory 100.

FIG. 1b depicts a second side of the first embodiment of the present invention. The non-mesh border 102b, the mesh panels 108b, and the non-mesh panels 104b may be the opposite side of the same material used for the border 102a, the mesh panels 108a, and the non-mesh panels 104a (shown in FIG. 1a), respectively. In another embodiment, the border 102b, the mesh panels 108b, and the non-mesh panels 104b may be constructed from a separate material from the border 102a, the mesh panels 108a and the non-mesh panels 104a, wherein the wind accessory 100 comprises two layers of material. The appliqués 106b may comprise of a separate material than the material used for appliqués 106a in order for the appliqués to be visible on both the first side of the wind accessory as shown in FIG. 1a, and the second side of the wind accessory as shown in FIG. 1b. The wind accessory 100 is commonly referred to as a flag.

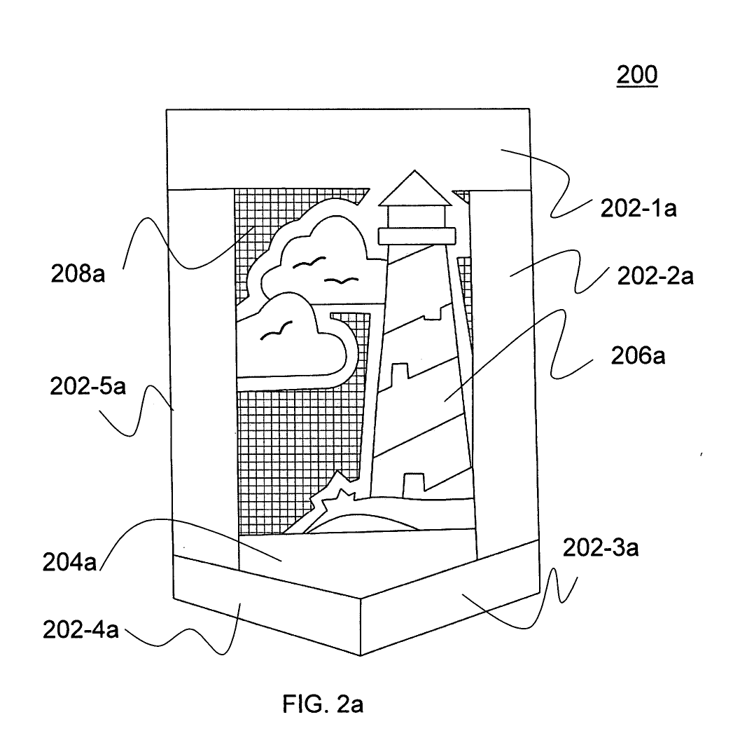

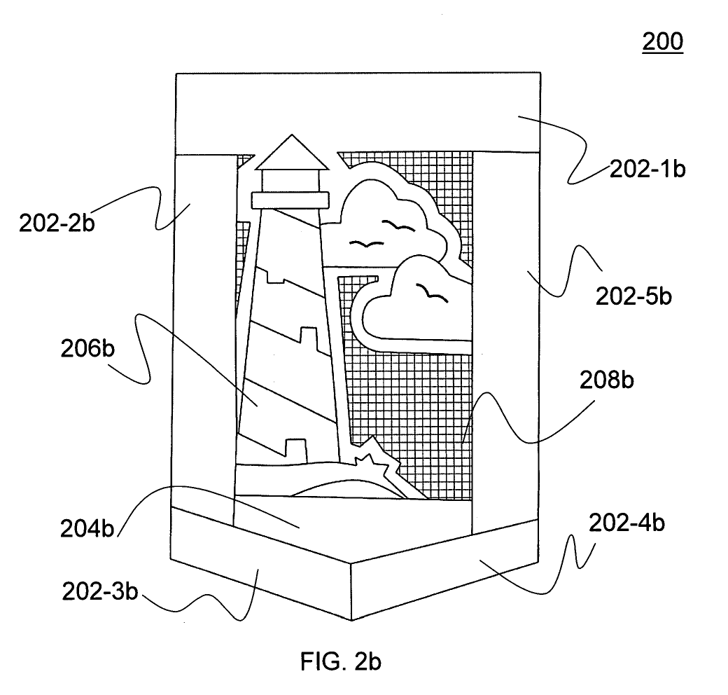

FIG. 2a depicts one side of a second embodiment of the present invention. The second embodiment is a wind accessory 200 depicting a scene of a lighthouse. The lighthouse scene depicted is just one of many scenes that may be depicted on such a wind accessory. The wind accessory 200 comprises a multi-panel, non-mesh border 202-1a-202-5a, a non-mesh panel 204a, non-mesh appliqués 206a, and a mesh panel 208a. The mesh panels 208a are connected with at least one portion of the multi-panel, non-mesh border 202-1a-202-5a. The non-mesh panel 204a is connected with at least one portion of the multi-panel, non-mesh border 202-1a-202-5a. Finally, the non-mesh appliqués 206a are connected with at least a portion of the mesh panel 204a.

Many different types of materials may be used in constructing the wind accessory 200. For example, the non-mesh portions of the wind accessory 200, such as the multi-portion, non-mesh border 202a, the non-mesh panel 204a, and the non-mesh appliqués 206a may be constructed from a nylon fabric. The non-mesh portions need not be constructed out of the same type of fabric. For example, the non-mesh border 202a may be constructed from a nylon fabric with a higher thread density than the non-mesh appliqués 206a. The mesh panel 208a may also be constructed out of any material, such as nylon. The number of holes per square inch for the mesh panel 208a may be varied depending upon the desired look and application of the wind accessory 200.

FIG. 2b depicts a second side of the second embodiment of the present invention. The multi-panel, non-mesh border 202-1b-202-5b, the mesh panel 208b, and the non-mesh panel 204b may be the opposite side of the same material used for the multi-panel, non-mesh border 202-1a-202-5a, the mesh panel 208a, and the non-mesh panel 204a (as shown in FIG. 2a), respectively. In another embodiment, the multi-panel, non-mesh border 202-1b-202-5b, the mesh panel 208b, and the non-mesh panel 204b may be constructed from separate material from the multi-panel, non-mesh border 202-1a-202-5a, the mesh panel 208a, and the non-mesh panel 204a, wherein the wind accessory 200 comprises two layers of material. The appliqués 206b may comprise of a separate material than the material used for appliqués 206a in order for the appliqués 206a, 206b to be visible on both the first side of the wind accessory as shown in FIG. 2a, and the second side of the wind accessory as shown in FIG. 2b. The wind accessory 200 is commonly referred to as a flag.

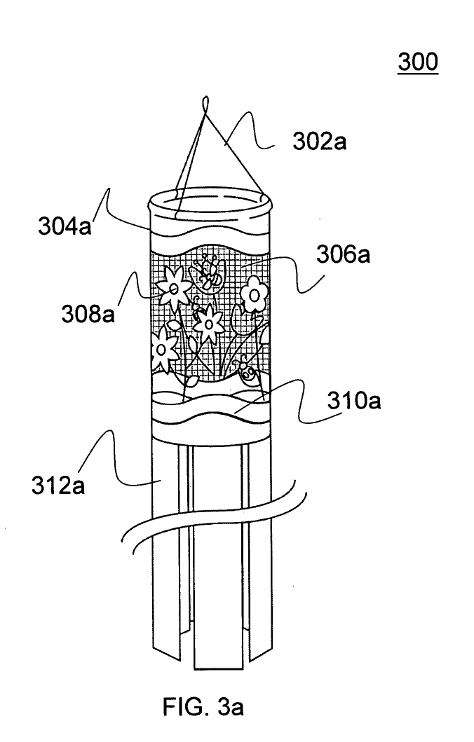

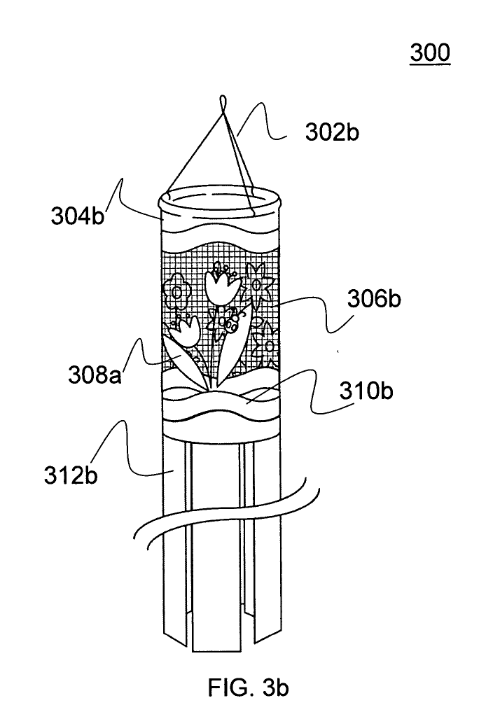

FIG. 3a depicts one side of a third embodiment of the present invention. The third embodiment is a wind accessory 300 depicting flowers. The flower scene depicted is just one of many scenes that may be depicted on such a wind accessory. The wind accessory 300 comprises an attachment 302a, a non-mesh, top border 304a, a mesh panel 306a, non-mesh appliqués 308a, a non-mesh, bottom border 310a, and non-mesh tails 312a. The attachment 302a is connected with at least a portion of the non-mesh, top border 304a. The mesh panel 306a is connected between at least a portion of the non-mesh, top border 304a, and a portion of the non-mesh, bottom border 310a. The non-mesh appliqués 308a are connected with at least a portion of the mesh panel 306a. The non-mesh tails are connected with at least a portion of the non-mesh, bottom border 310a.

Many different types of materials may be used in constructing the wind accessory 300. For example, the non-mesh portions of the wind accessory, such as the top border 304a, the bottom border 310a, the appliqués 308a, and the tails 312a may be constructed from a nylon fabric. The non-mesh portions need not be constructed out of the same type of fabric. For example, the non-mesh, top border 304a may be constructed from a nylon fabric with a higher thread density than the non-mesh appliqués 308a. The mesh panel 306a may also be constructed out of any material, such as nylon. The number of holes per square inch for the mesh panel 306a may be varied depending upon the desired look and application of the wind accessory 300.

FIG. 3b depicts a second side of the third embodiment of the present invention. The wind accessory 300 is tubular in shape. Therefore, the elements described above in relation to FIG. 3a are positioned in the same order as those shown in FIG. 3b. The wind accessory 300 is a commonly referred to as a windsock.

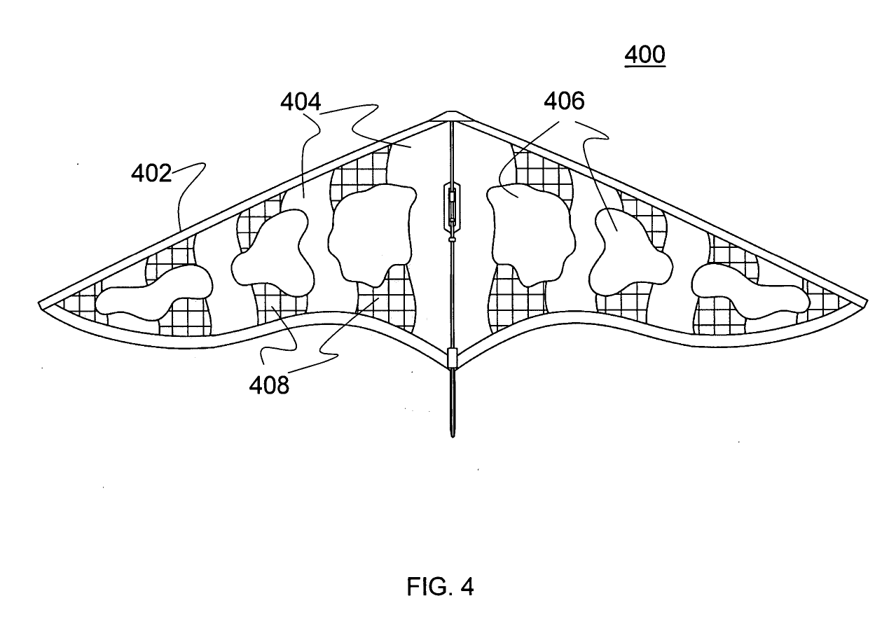

FIG. 4 depicts a fourth embodiment of the present invention. The fourth embodiment is a wind accessory 400 which is a kite. The design on the wind accessory 400 is just one of many designs that may be depicted on such a kite. The wind accessory 400 comprises a non-mesh border 402, non-mesh panels 404, non-mesh appliqués 406, and mesh panels 408. The mesh panels 408 are connected with at least one of portion of the non-mesh border 402. The non-mesh panels are connected with at least one portion of the non-mesh border 402. Finally, the non-mesh appliqués 406 are connected with at least a portion of the mesh panels 408.

Many different types of materials may be used in constructing the wind accessory 400. For example, the non-mesh portions of the wind accessory 200, such as the non-mesh border 402, the non-mesh panels 404, and the non-mesh appliqués 406 may be constructed from a nylon fabric. The non-mesh portions need not be constructed out of the same fabric. For example, the non-mesh border 402 may be constructed from a nylon fabric with a higher thread density than the non-mesh appliqués 406. The mesh panel 408 may also be constructed out of any material such as nylon. The number of holes per area (or square inch) for the mesh panels 408 may be varied depending upon the desired look and application of the wind accessory 400.

An additional aspect of the present invention is a method of forming a wind accessory comprising acts of obtaining a non-mesh border; obtaining a mesh panel; connecting a mesh panel with at least a portion of the non-mesh border; and applying a non-mesh appliqué with at least a portion of the mesh panel. Furthermore, the method comprises the act of obtaining a non-mesh panel and connecting the non-mesh panel with at least a portion of the mesh panel.

The method comprising the act of obtaining a non-mesh border comprises an act of selecting a material having a first thread density; and the act of obtaining a non-mesh appliqué comprises an act of selecting a material having a second thread density, wherein the first thread density is greater than the second thread density.

In the method comprising the act of obtaining a non-mesh border, further acts joining a first non-mesh border panel with a second non-mesh border panel are comprised. The act of obtaining a mesh panel further comprises an act of obtaining a tubular mesh panel.

The method comprising the act of changing the properties of a wind accessory comprise acts of determining an application for the wind accessory; selecting a mesh panel having a number of holes per area based on the application; and constructing the wind accessory by: connecting the mesh panel to a non-mesh border; and applying a non-mesh appliqué with at least a portion of the mesh panel.

The method comprising the act of constructing the wind accessory further comprises acts of obtaining a non-mesh panel; and connecting the non-mesh panel with at least a portion of the mesh panel.

The method comprising the act of constructing the wind accessory further comprises acts of selecting a material for the non-mesh border having a first thread density; and selecting a material for the appliqué having a second thread density, wherein the first thread density is greater than the second thread density, such that the act of joining a first non-mesh border panel with a second non-mesh border panel forms the non-mesh border.

1. A wind accessory comprising:
a non-mesh border;
a mesh panel connected with at least a portion of the non-mesh border; and
a non-mesh appliqué connected with at least a portion of the mesh panel.

2. The wind accessory of claim 1, further comprising a non-mesh panel connected with at least a portion of the non-mesh border and a portion of the mesh panel.

3. The wind accessory of claim 1, wherein:
the non-mesh border has a first thread density; and
the non-mesh appliqué has a second thread density,
wherein the first thread density is greater than the second thread density.

4. The wind accessory of claim 1, wherein the wind accessory has a first side and a second side and a second non-mesh appliqué, and wherein the mesh panel is visible from both the first side and the second side, the non-mesh appliqué is visible from the first side, and the second non-mesh appliqué is visible from the second side.

5. The wind accessory of claim 1, wherein the non-mesh border comprises of at least two non-mesh border panels.

6. The wind accessory of claim 1, wherein the wind accessory is a flag.

7. The wind accessory of claim 1, wherein the wind accessory is substantially tubular.

8. The wind accessory of claim 7, wherein the wind accessory is a windsock.

9. The wind accessory of claim 1, wherein the wind accessory is a kite.

10. A method of forming a wind accessory comprising acts of:
obtaining a non-mesh border;
obtaining a mesh panel;
connecting a mesh panel with at least a portion of the non-mesh border; and
applying a non-mesh appliqué with at least a portion of the mesh panel.

11. The method of claim 10 further comprising acts of:
obtaining a non-mesh panel; and
connecting the non-mesh panel with at least a portion of the mesh panel.

12. The method of claim 10, wherein:
the act of obtaining a non-mesh border comprises an act of selecting a material having a first thread density; and
the act of obtaining a non-mesh appliqué comprises an act of selecting a material having a second thread density,
wherein the first thread density is greater than the second thread density.

13. The method of claim 10, wherein the act of obtaining a non-mesh border comprise acts of:
joining a first non-mesh border panel with a second non-mesh border panel.

14. The method of claim 10, wherein the act of obtaining a mesh panel further comprises an act of obtaining a tubular mesh panel.

15. The method of changing the properties of a wind accessory comprising acts of:
determining an application for the wind accessory;
selecting a mesh panel having a number of holes per area based on the application; and
constructing the wind accessory by:
connecting the mesh panel to a non-mesh border; and
applying a non-mesh appliqué with at least a portion of the mesh panel.

16. The method of claim 15, wherein the act of constructing the wind accessory further comprises acts of:
obtaining a non-mesh panel; and
connecting the non-mesh panel with at least a portion of the mesh panel.

17. The method of claim 15, wherein the act of constructing the wind accessory further comprises acts of:
selecting a material for the non-mesh border having a first thread density; and
selecting a material for the appliqué having a second thread density,
wherein the first thread density is greater than the second thread density.

18. The method of claim 15, further comprising an act of joining a first non-mesh border panel with a second non-mesh border panel, whereby the non-mesh border is formed.

19. The method of claim 15, wherein the act of constructing the wind accessory further comprises an act of forming the wind accessory into a tubular form.
